(19) United States
(12) Patent Application Publication
(10) Pub. No.: US 2019/0080269 A1
(43) Pub. Date: Mar. 14, 2019

(54) DATA CENTER SELECTION FOR CONTENT ITEMS

(71) Applicant: INTERNATIONAL BUSINESS MACHINES CORPORATION, Armonk, NY (US)

(72) Inventors: Uwe Hansmann, Tuebingen (DE); Daniel Kaulen, Boeblingen (DE); Timo Kußmaul, Boeblingen (DE); Klaus Rindtorff, Weil im Schoenbuch (DE)

(21) Appl. No.: 15/700,350

(22) Filed: Sep. 11, 2017

(51) Int. Cl. G06Q 10/06; G06Q 10/04; G06F 1/32

(52) U.S. Cl. CPC G06Q 10/0633; G06F 9/50; G06F 1/329; G06Q 10/04

(57) ABSTRACT

A method, system, and/or a computer program product is provided for assigning a content item to a data center and for storing the content item in the data center. The method comprises reading a workflow definition. The workflow definition comprises a plurality of states for a content item. A state is determined of the content items in its related workflow, and probabilities are determined for future workflow states using author profiles performing future workflow steps resulting in the future workflow states. Furthermore, a data center performance indicator is determined for each of a plurality of data centers enabled for storing the content item, and a content item storage indicator is determined using the determined probabilities and the determined data center performance indicator for each of the plurality of data centers. The content item is stored in that data center which related content item storage indicator exceeds a predefined threshold value.

### FIELD

The invention relates generally to a method and system for assigning a content item to a data center, and more specifically, to a method and system also for storing the content item in the data center.

### BACKGROUND

The infrastructure investments that are made in data centers represent a substantial part of an operational budget for an organization. The need to balance efficiency and resilience of those investments is prompting organizations to pursue multi-site data center strategies. Among the selection criteria for data center locations are, for example, communication infrastructure costs, climate conditions, local tax, local incentives, workforce skills, wages, electrical services, cooling facilities and so on. All of them contribute to the overall cost of maintaining a data center.

However, not all data centers of an organization may have the same size in terms of computing power, availability and/or cost structure. A typical website, portal page or content management system integrates software components for authoring and publishing, as well as applications such as search, e-commerce and further client-side or server-side applications and interfaces to back-end systems. These are often implemented in a micro-service architecture. Identifying the optimal subset of data centers for hosting content authoring services, as well as the content items itself, is crucial for the success of cloud service providers and clients alike. Generally, this process requires to weigh up between multiple competing objectives (e.g., cost and reliability). Today, the selection of data centers for the above-mentioned services does not appropriately reflect all related requirements.

Therefore, decisions need to be made where to execute certain services and/or store certain data. Enterprise scale organizations often work based on workflows to support their enterprise processes, e.g., in the area of content creation, content management and content publication. Different stages of such a content creation-to-publishing workflow often involves a plurality of different authors and/or reviewers collaborating in the creation and publication of certain content items. These authors and/or reviewers may be located at different locations around the globe. Thus, they may be closer or further away from a specific data center such that communication and other costs may be significantly influenced depending on the user location and the data center location/environment. Therefore, enterprises look for an optimization of storage decisions for content items if a plurality of data centers at different locations with different operating parameters are available.

### SUMMARY

According to one aspect of the present invention, a method for assigning a content item to a data center and for storing the content item in the data center may be provided. The method may comprise reading a workflow definition for the content item from a content authoring service. The workflow definition may comprise a plurality of states for the content item.

The method may further comprise determining a state of the content item in its related workflow, determining probabilities for future workflow states of the content item using author profiles performing future workflow steps resulting in the future workflow states.

The probability determination may use previous workflow execution logs for determining a plurality of author access probabilities indicative of a probability that an author accesses the content item.

Additionally, the method may comprise determining a data center performance indicator for each of a plurality of data centers enabled for storing the content item, determining a content item storage indicator using the determined probabilities and the determined data center performance indicator for each of the plurality of data centers, and storing the content item in that data center which related content item storage indicator exceeds a predefined threshold value.

According to another aspect of the present invention, a system for assigning a content item to a data center and for storing the content item in the data center may be provided. The system may comprise a reading unit adapted for reading a workflow definition for the content item in a content management system. The workflow definition may comprise a plurality of states for the content item.

The system may further comprise a first determination engine adapted for determining a state of the content item in its related workflow and, a second determination engine adapted for determining probabilities for future workflow states of the content items using author profiles performing future workflow steps resulting in the future workflow states. The second determination engine may also be adapted for using previous workflow execution logs for determining a plurality of author access probabilities for a plurality of authors, wherein the access probability is indicative of a probability that a certain author accesses the content item.

Moreover, the system may comprise a third determination engine adapted for determining a data center performance indicator for each of a plurality of data centers enabled for storing the content item, a fourth determination engine adapted for determining a content item storage indicator using the determined probabilities and the determined data center performance indicator for each of the plurality of data centers, and a storage unit adapted for storing the content item in that data center which related content item storage indicator exceeds a predefined threshold value.

Furthermore, embodiments may take the form of a related computer program product, accessible from a computer-usable or computer-readable medium providing program code for use, by or in connection with a computer or any instruction execution system. For the purpose of this description, a computer-usable or computer-readable medium may be any apparatus that may contain means for storing, communicating, propagating or transporting the program for use, by or in a connection with the instruction execution system, apparatus, or device.

According to another aspect of the present invention, a computer program product for assigning a content item to a data center and for storing the content item in the data center may be provided. The computer program product comprises a computer readable storage medium having program instructions embodied therewith, and the program instructions are executable by one or more computing systems to cause the one or more computing systems to: read a workflow definition for content items in a content authoring service, wherein the workflow definition comprises a plurality of states for a content; determine a state of one of the content items in its related workflow; determine probabilities for future workflow states of the content item using author profiles performing future workflow steps resulting in the future workflow states, wherein the probability determination uses previous workflow execution logs for determining a plurality of author access probabilities for a plurality of authors indicative of a probability that an author accesses the content item; determine a data center performance indicator for each of a plurality of data centers enabled for storing the content item; determine a content item storage indicator using the determined probabilities and the determined data center performance indicator for each of the plurality of data centers; and store the content item in that data center which related content item storage indicator exceeds a predefined threshold value.

### BRIEF DESCRIPTION OF THE SEVERAL VIEWS OF THE DRAWINGS

It should be noted that embodiments of the invention are described with reference to different subject-matters. In particular, some embodiments are described with reference to method type claims whereas other embodiments have been described with reference to apparatus type claims. However, a person skilled in the art will gather from the above and the following description that, unless otherwise notified, in addition to any combination of features belonging to one type of subject-matter, also any combination between features relating to different subject-matters, in particular, between features of the method type claims, and features of the apparatus type claims, is considered as to be disclosed within this document.

The aspects defined above and further aspects of the present invention are apparent from the examples of embodiments to be described hereinafter and are explained with reference to the examples of embodiments, but to which the invention is not limited.

Preferred embodiments of the invention will be described, by way of example only, and with reference to the following drawings:

FIG. 1 shows a block diagram of an embodiment of the inventive method for assigning a content item to a data center and for storing the content item in the data center;

FIG. 2 shows a block diagram of an embodiment of a more detailed flow diagram for the proposed method;

FIG. 3 shows a block diagram of a sample workflow;

FIG. 4 shows a block diagram of an embodiment of the system for assigning a content item to a data center and for storing the content item in the data center; and

FIG. 5 shows an embodiment of a computing system comprising the system according to FIG. 4.

### DETAILED DESCRIPTION

In the context of this description, the following conventions, terms and/or expressions may be used:

The term ‘content item’ may denote a content fragment to be published in, e.g., a web portal or any other information access system. Typically, web browsers may be used to display content items in window oriented systems, e.g., portal systems. The content item may be text based, image based, sound based, video based and/or a combination thereof. In more complex environments, the content item may also be an entry in an electronic shopping system, a self-learning environment or a materialized element of any other interactive content management system.

The term ‘data center’ may denote a collection of compute, storage and network resources managed as a larger entity. More generally, a data center may be a facility used to house computer systems and associated components, such as telecommunications and storage systems. It may generally include redundant or backup power supplies, redundant data communications connections, environmental controls (e.g., air conditioning, fire suppression) and various security devices. A data center may either be a small back room with a couple of servers or an enterprise or cloud scale compute environment with thousands (or tens of thousands) of compute nodes.

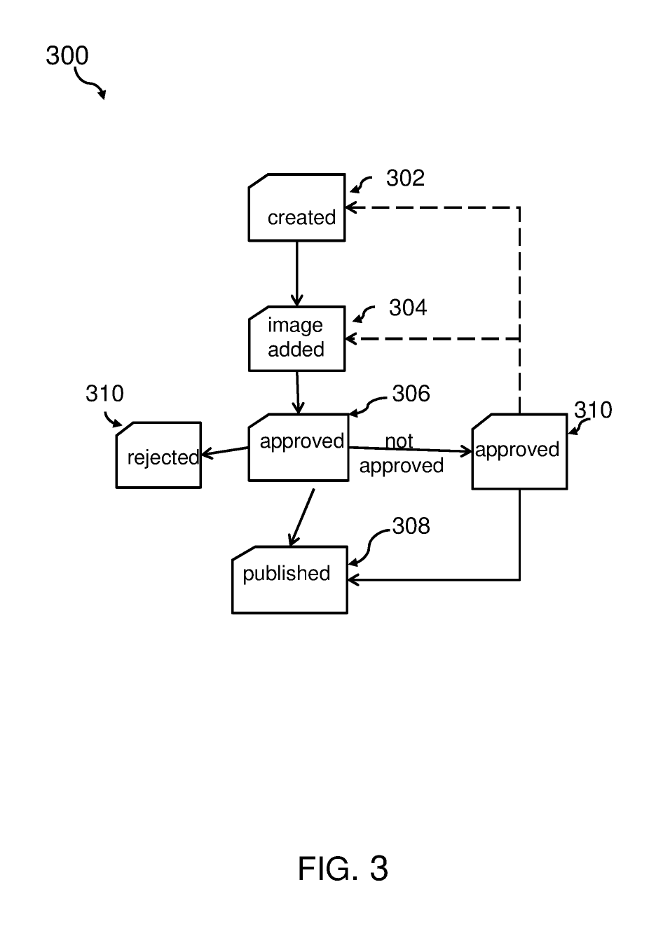

The term ‘workflow’ may denote a sequence of steps a document or a process may pass over a period of time. A workflow may consist of an orchestrated and repeatable pattern of activities enabled by the systematic organization of resources into processes that transform materials, provide services, or process information. It may be depicted as a sequence of operations, declared as work of a person or group, an organization or staff, or one or more simple or complex mechanisms or machines.—From a more abstract or higher-level perspective, a workflow may be considered as a view or representation of real work. The flow being described may refer to a document, service or product that is being transferred from one step or status to another. The workflow may be defined—i.e., having a workflow definition—such that the stages or statuses of the workflow may be predefined for a given workflow. In this context, the term ‘alternative sub-workflow’ may denote a deviation from a main route of a workflow. A simple example is shown in the figures (compare FIG. 3).

The term ‘content authoring service’ may denote a service available from a content management system or authoring system being executed by a computer system. The content authoring service may enable a creation of a content item by an author using a content editor and/or it may allow reviewing and chancing the content items by a reviewer. For simplicity reasons, all users having access to the content item—either create or change—may be denoted as author in the context of this document.

The term ‘probability for a future workflow state’ may denote a chance that the content item, once created, will be a state defined by the workflow at a later point in time. Workflows can be non-linear in the sense that they may have forks and merging positions at later points in time. A simple example is shown in the figures.

The term ‘data center performance indicator’ may denote efficiency, a capacity, productivity, capability and/or even performance of computing devices in the data center. The performance may depend on a plurality of influential factors like latency in the communication network between a user and the data center, risk of natural disaster at the location of the data center, cost of operation of the data center and/or fulfilment of boundary conditions like, e.g., fulfilment of or compliance with legal requirements for the data center.

The term ‘content item storage indicator’ may denote a mathematical combination of the probability for a future workflow state and the data center performance indicator. A multiplication may be a simple combination. Other mathematical formula may be applied. This way a single numerical value may be generated in order to compare it against a threshold value. This may be instrumental for deciding in which data center the content item should be stored.

The proposed method for assigning a content item to a data center and for storing the content item in the data center may offer multiple advantages and technical effects:

Automatically selecting a data center for storing a content item as part of a content creation activity using a content authoring service or content management system may be a critical success factor for service providers offering content authoring services and/or content management systems to enterprises. Cost of operation of a data center, as well as access reliability and compliance to various regulations and boundary conditions, play a key role in the pricing of content authoring services and thus, in the competitiveness of related offerings of service providers. Being able to decide after each workflow step of the content creation, content review and content publishing in which data center or data centers the specific content item under work should be stored, may allow increasing the access reliability and/or decreasing the access time to the content item. This may increase the productivity of the content creation. Various parameters can be reflected using the here proposed concepts. These may depend on key performance indicators of the data center(s) on the one hand side, and on the relationship between different authors being involved in the workflow of the content creation from the first workflow step to the final workflow step on the other hand side.

Storing the content item under construction—or as a published content item—in not only one but a plurality of different data centers under the above-mentioned boundary conditions decreases the risk for not being able to access the content item at any time. Additionally, not the user, i.e., author/reviewer, has a need to decide where to store the content item after a next workflow step but the here proposed system, using the proposed method, performs this determination task automatically, thus, making the decision unbiased.

Overall, the access speed to the content item may be increased, the reliability of the access to the content item may be increased, and the management and storage costs for the content item may be decreased. This will help to increase the quality of the content item and thus the content producer, as well as the competitiveness of the service provider providing the content authoring service as well as the storage service for the content items.

In the following additional embodiments of the proposed method and related system will be described:

According to an optional embodiment of the method, the workflow may comprise at least one alternative sub-workflow to reach a final status starting from an initial status. Thus, the proposed method is not only working with a linear workflow definition but also workflows branching out, e.g., dependent on a schedule or a profile of a reviewer with higher privileges, e.g., being allowed not only to give feedback but also to publish a content item directly.

According to one permissive embodiment of the method, each of the data centers may be selected from a list of data centers already used for storage of the content item. Thus, only data centers with which usage experience data are available may be selected as storage location for the content item.

According to another permissive embodiment of the method, at least one of the data centers may be selected from a list of data centers not yet used for storage of the content item. This may extend the list of potential data centers. The risk may eventually be bit higher but other critical criteria may be met—e.g., compliance with regulatory requirements and/or lower costs.

If not any suitable data center—in particular one not being compliant with the predefined threshold value—may be found in the list of data centers not yet used for a storage of the content item, the method may comprise recommending to open a new data center compliant with the predefined threshold value. Such a feature may severe advantages to the management of the workflow of the content creation as well as to the management of data centers for service providers as they may get fact and requirement based recommendations for the daily operations. It may also be useful to generate such an overall recommendation only after a predefined minimum number of sub-recommendations have been generated by a series of different workflows.

According to one advantageous embodiment of the method, each of the data center performance indicators for the data center is at least one selected out of the group comprising a latency in a communication network between a user device—in particular one from which the content item may be changed—and the data center, a risk of natural disaster at location of the data center, geographical location, cost of operation of the data center and compliance with predefined rules. These predefined rules may comprise legal requirements, compliance with data security regulations, worker security rules or worker benefit regulations, any other government or non-government regulation or norm and/or a combination thereof. Thus, the data center performance indicator may reflect a plurality of different criteria. The definition of the data center performance indicators may change over time in order to reflect a different set of boundary conditions. Thus, weights for different criteria may help to adopt the data center performance indicator with enterprise requirements.

According to one preferred embodiment of the method, each of the performance indicators of a data center may be estimated based on historic values, estimated based on forecast values—in particular for criteria of partial components or key performance indicators of the data center performance indicator—or calculated based on actual measurement values over time. Hence, the data center performance indicators may cover a large variety of different conditions and characteristics of the involved data centers and requirements of the content items.

According to a further preferred embodiment of the method, determining the performance indicator may comprise determining satisfaction ratings—e.g., based on a fulfilment rating or a score regarding requirements—between each of a plurality of key performance indicators of the data center in comparison to related requirements in regard to the storage of the content item. The determining the performance indicator may also comprise building a sum of all individual satisfaction ratings, and sorting the data centers into an ordered list depending on the sum of the related satisfaction ratings. This way, the best suitable data center may be selected for storing the content item.

According to one advantageous embodiment of the method, a cognitive engine may be used for determining a trend of the data center performance indicators and/or its components. This may, e.g., be achieved based on a trend analysis regarding satisfaction ratings between each of a plurality of key performance indicators of the data center in comparison to related requirements in regards to the storage of the content item. The cognitive engine may be tuned to identify trends in a short amount of time if compared to classical computing systems.

According to one additionally preferred embodiment of the method, determining probabilities for future workflow states may be based on a function comprising a collaboration coefficient indicative of a relationship between a first author and a second author working on content items in a given workflow. This may be derivable from past execution logs. Some authors and reviewers may have a higher probability of working together. That may be because both work on similar topics regarding the content items, they may know each better than others or have another binding relationship (e.g., by belonging to the same organizational department or groups).

According to one optional embodiment, the method also comprise creating a script for storing the content item in one or more of the data centers exceeding the predefined threshold value after every finished workflow step. Hence, the content authoring service has no need to care about the storage of the content item under production. The proposed method and related system ensure automatically that an optimal or best suited storage location—i.e., data center—is selected under the constraints given.

In the following, a detailed description of the figures will be given. All instructions in the figures are schematic. Firstly, a block diagram of an embodiment of the inventive method for assigning a content item to a data center and for storing the content item in the data center is given. Afterwards, further embodiments, as well as embodiments of the system for assigning a content item to a data center and for storing the content item in the data center, will be described.

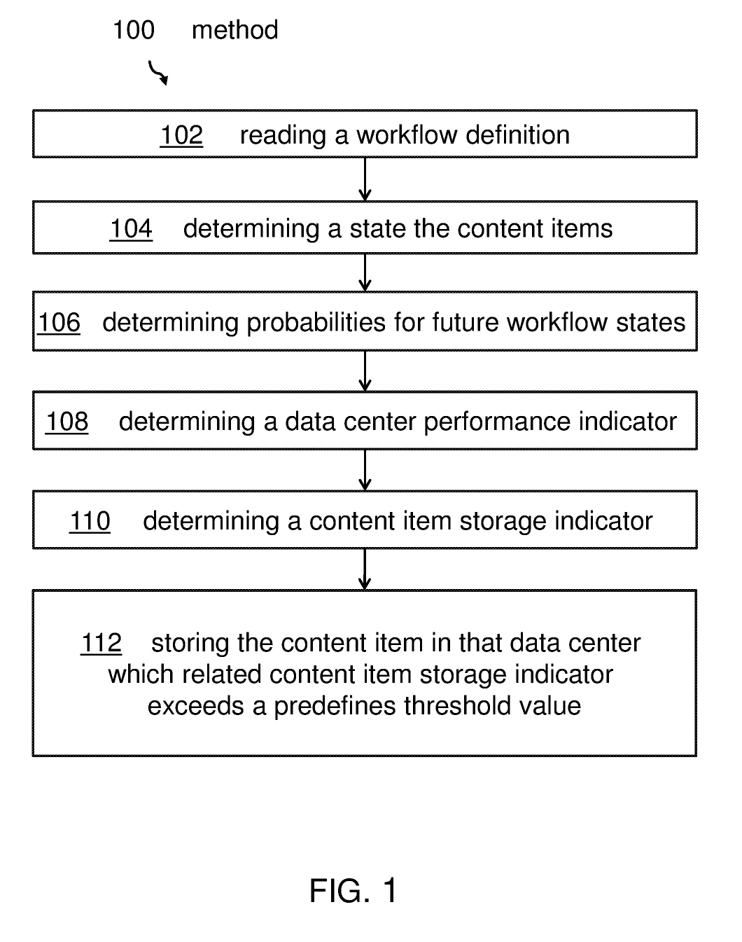

FIG. 1 shows a block diagram of an embodiment of the method 100 for assigning a content item to a data center and for storing the content item in the data center. The method 100 comprises reading, 102, a workflow definition for content items in a content authoring service or content management and/or content creating system. The workflow definition comprises a plurality of states for a content item. Examples of states may be ‘draft’, ‘in 1st review’, ‘after 1st review’, ‘in 2nd review’, ‘after 2nd review’, ‘approved’, ‘not approved/rejected’ or ‘published’, just to name a few. The workflow does not have to be straight, following waterfall model, but may have branches and loops.

The method 100 comprises further determining, 104, a state of the content item in its related workflow, determining, 106, probabilities for future workflow states of the content items using author profiles performing future workflow steps resulting in the future workflow states. The probability determination uses previous workflow execution logs for determining a plurality of authors—e.g., reviewers—access probabilities for a plurality of authors indicative of a probability that another author than the one having created the content items accesses the content item. This probability determination may be performed on a 1:n basis, i.e., for a given original content author, an access probability is determined for other authors/reviewers known to the content authoring service by, e.g., author/reviewer profiles and/or past execution logs. This may express a past relationship between an original author and reviewers which may be specific for a specific topic the content item is addressing. It may also be a measure for probabilities for potential content authors/reviewers for accessing the content item in any of the future workflow states.

The method 100 comprises additionally determining, 108, a data center performance indicator for each of a plurality of data centers enabled for storing the content item. The data center performance indicator may summarize a plurality of performance parameters—see above—under different aspects. However, the determination method for determining the data center performance indicator is the same for all data center performance indicators across the data center for comparability reasons.

Furthermore, the method 100 comprises determining, 110, a content item storage indicator using the determined probabilities and the determined data center performance indicator for each of the plurality of data centers. This may be done by any mathematical relationship building; a multiplication or building the sum of the two values may be two alternative methods.

The method 100 comprises storing, 112, the content item in at least one of the data centers which related content item storage indicator exceeds a predefined threshold value. The status of the content item may be stored together with the content item or in a separate management system, e.g., the content authoring system.

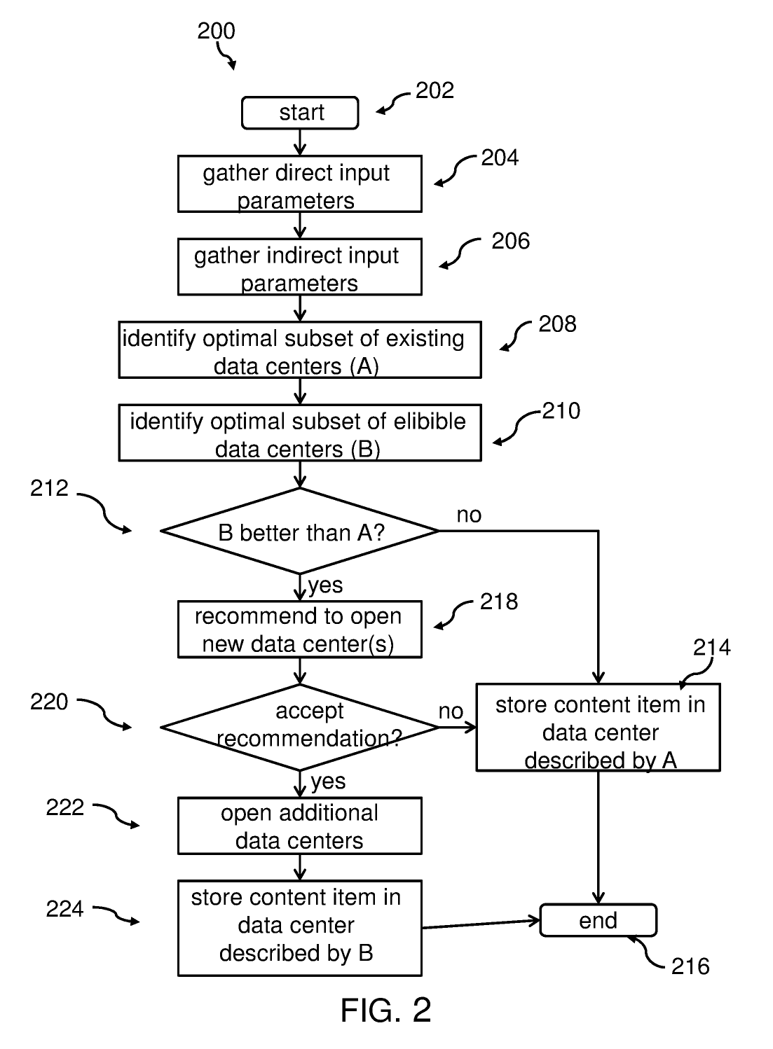

FIG. 2 shows a block diagram of an embodiment of a more detailed and expanded flow diagram 200 for the proposed method 100. The flow diagram 200 starts at 202. Initially, direct and indirect input parameters—like the content item, the workflow definition, status definitions of the workflow, author/reviewer profiles, KPI (key performance indicator) definitions and values—are collected from respective storage sites and systems, 204, 206. Then, in step 208, an optimal subset of existing data centers—determined by the method according to the here proposed concept—may be determined. This determination is directed to already existing data centers which have been used in the past. In a next step 210, additionally, the eligibility of the data center is determined. In case, B is better than A—step 212—it is recommended to open one or more new data centers or make them available for the storage of the content item, 218.

If the recommendation is accepted—determination 220—one or more additional data centers will be made available (opened), 222, for the here proposed method 100; and the content item will be stored there, 224. The process then ends at 216. If no data center satisfies the threshold condition for a data center and to store the content item, a warning may be send to the current active author and he may decide where to store the newly changed content item. Alternatively, the content item may be stored from where it was accessed.

If at determination 212 the answer is ‘no’, or if the recommendation is not accepted at 220, then the content item is stored in the data center, described by A, 214. Also in this case, the process ends at 216.

FIG. 3 shows a block diagram of a sample workflow 300. An author may create a content item at 302 and the status ‘created’. If another author, at 304, may add an image or modify or enhance the content item, then, at 306, another author or reviewer reviews the content item and may approve it, so that the content item may be published, 308. Alternatively, he could not approve it and send it to another reviewer. Here, at 310, the additional reviewer may change the content item and then approve it directly for publishing, 308. Alternatively, at 306, the content item may also be rejected, 310.

If the second reviewer at 310 may decide that the image might not fit, he may direct the content item back to stage 306 to modify the image, or to stage 302 for a modification of the original content item. Additional content may now have been added to the content item. From here, the content item may pass through the workflow 300 again. This sample workflow shall demonstrate that the workflow in the context of this document may have any subsequent flow of activities for a content item including loops and branches compared to a mere waterfall model of a simple workflow. Hence, sub-workflows may be part of the overall workflow.

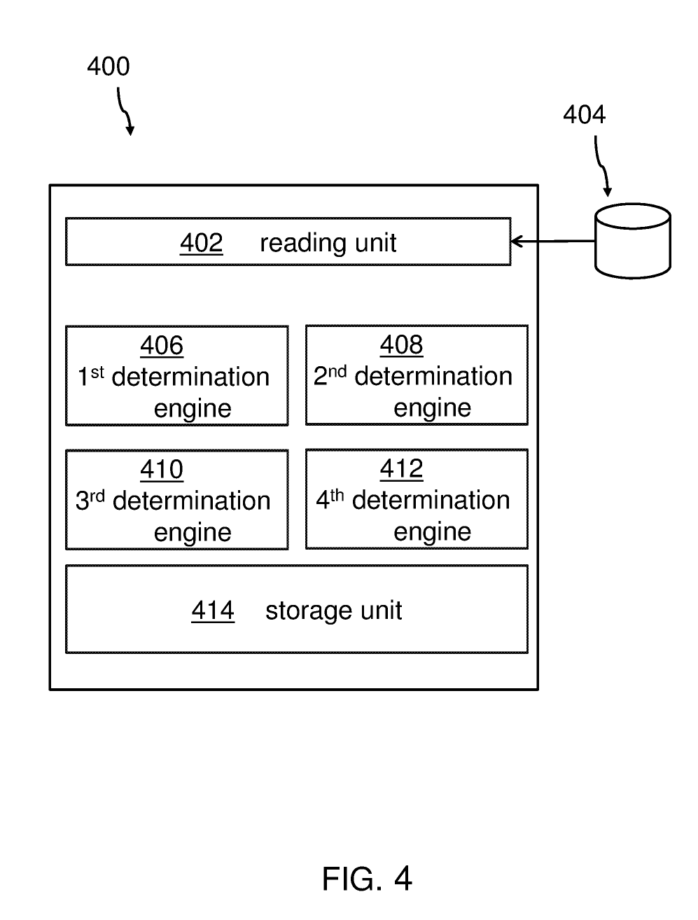

FIG. 4 shows a block diagram of an embodiment system 400 for assigning a content item to a data center and for storing the content item in the data center. The system 400 comprises a reading unit 402 adapted for reading a workflow definition 404 for content items in a content management system. The workflow definition 404 comprises a plurality of states for a content item.

The system 400 further comprises a first determination engine 406 adapted for determining a state of one of the content items in its related workflow and a second determination engine 408 adapted for determining probabilities for future workflow states of the one of the content items using author profiles performing future workflow steps resulting in the future workflow states. The second determination engine 408 is also adapted for using previous workflow execution logs for determining a plurality of author access probabilities for a plurality of authors indicative of a probability that an author accesses the content item.

Moreover, the system 400 comprises a third determination engine 410 adapted for determining a data center performance indicator for each of a plurality of data centers enabled for storing the content item and a fourth determination engine 412 adapted for determining a content item storage indicator using the determined probabilities and the determined data center performance indicator for each of the plurality of data centers, as well as, a storage unit 414 adapted for storing the content item in that data center which related content item storage indicator exceeds a predefined threshold value.

This way, it may be ensured that the content item is always stored at one or more data centers in order to ensure maximum availability and speed of access to the content item for workflow states being triggered after the storage of the content item.

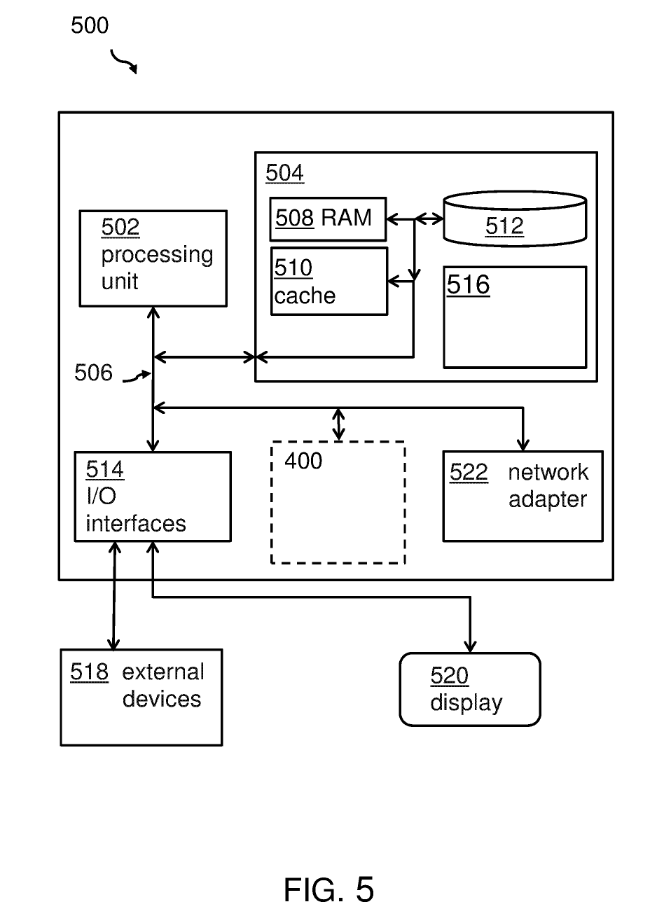

Embodiments of the invention may be implemented together with virtually any type of computer, regardless of the platform being suitable for storing and/or executing program code. FIG. 5 shows, as an example, a computing system 500 suitable for executing program code related to the proposed method.

The computing system 500 is only one example of a suitable computer system and is not intended to suggest any limitation as to the scope of use or functionality of embodiments of the invention described herein. Regardless, computer system 500 is capable of being implemented and/or performing any of the functionality set forth hereinabove. In the computer system 500, there are components, which are operational with numerous other general purpose or special purpose computing system environments or configurations. Examples of well-known computing systems, environments, and/or configurations that may be suitable for use with computer system/server 500 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like. Computer system/server 500 may be described in the general context of computer system-executable instructions, such as program modules, being executed by a computer system 500. Generally, program modules may include routines, programs, objects, components, logic, data structures, and so on that perform particular tasks or implement particular abstract data types. Computer system/server 500 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 5, computer system/server 500 is shown in the form of a general-purpose computing device. The components of computer system/server 500 may include, but are not limited to, one or more processors or processing units 502, a system memory 504, and a bus 506 that couples various system components including system memory 504 to the processor 502. Bus 506 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus. Computer system/server 500 typically includes a variety of computer system readable media. Such media may be any available media that is accessible by computer system/server 500, and it includes both, volatile and non-volatile media, removable and non-removable media.

The system memory 504 may include computer system readable media in the form of volatile memory, such as random access memory (RAM) 508 and/or cache memory 510. Computer system/server 500 may further include other removable/non-removable, volatile/non-volatile computer system storage media. By way of example only, storage system 512 may be provided for reading from and writing to a non-removable, non-volatile magnetic media (not shown and typically called a ‘hard drive’). Although not shown, a magnetic disk drive for reading from and writing to a removable, non-volatile magnetic disk (e.g., a ‘floppy disk’), and an optical disk drive for reading from or writing to a removable, non-volatile optical disk such as a CD-ROM, DVD-ROM or other optical media may be provided. In such instances, each can be connected to bus 506 by one or more data media interfaces. As will be further depicted and described below, memory 504 may include at least one program product having a set (e.g., at least one) of program modules that are configured to carry out the functions of embodiments of the invention.

The program/utility, having a set (at least one) of program modules 516, may be stored in memory 504 by way of example, and not limitation, as well as an operating system, one or more application programs, other program modules, and program data. Each of the operating system, one or more application programs, other program modules, and program data or some combination thereof, may include an implementation of a networking environment. Program modules 516 generally carry out the functions and/or methodologies of embodiments of the invention as described herein.

The computer system/server 500 may also communicate with one or more external devices 518 such as a keyboard, a pointing device, a display 520, etc.; one or more devices that enable a user to interact with computer system/server 500; and/or any devices (e.g., network card, modem, etc.) that enable computer system/server 500 to communicate with one or more other computing devices. Such communication can occur via Input/Output (I/O) interfaces 514. Still yet, computer system/server 500 may communicate with one or more networks such as a local area network (LAN), a general wide area network (WAN), and/or a public network (e.g., the Internet) via network adapter 522. As depicted, network adapter 522 may communicate with the other components of computer system/server 500 via bus 506. It should be understood that although not shown, other hardware and/or software components could be used in conjunction with computer system/server 500. Examples, include, but are not limited to: microcode, device drivers, redundant processing units, external disk drive arrays, RAID systems, tape drives, and data archival storage systems, etc.

Additionally, a system 400 for assigning a content item to a data center and for storing the content item in the data center may be attached to the bus system 506.

The descriptions of the various embodiments of the present invention have been presented for purposes of illustration, but are not intended to be exhaustive or limited to the embodiments disclosed. Many modifications and variations will be apparent to those of ordinary skills in the art without departing from the scope and spirit of the described embodiments. The terminology used herein was chosen to best explain the principles of the embodiments, the practical application or technical improvement over technologies found in the marketplace, or to enable others of ordinary skills in the art to understand the embodiments disclosed herein.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to limit the invention. As used herein, the singular forms “a”, “an” and “the” are intended to include the plural forms as well, unless the context clearly indicates otherwise. It will further be understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or steps plus function elements in the claims below are intended to include any structure, material, or act for performing the function in combination with other claimed elements, as specifically claimed. The description of the present invention has been presented for purposes of illustration and description, but is not intended to be exhaustive or limited to the invention in the form disclosed. Many modifications and variations will be apparent to those of ordinary skills in the art without departing from the scope and spirit of the invention. The embodiments are chosen and described in order to best explain the principles of the invention and the practical application, and to enable others of ordinary skills in the art to understand the invention for various embodiments with various modifications, as are suited to the particular use contemplated.

What is claimed is:

1. A method for assigning a content item to a data center and for storing said content item in said data center, said method comprising:
reading a workflow definition for content items in a content authoring service, wherein said workflow definition comprises a plurality of states for a content item;
determining a state of said content item in its related workflow;
determining probabilities for future workflow states of said content item using author profiles performing future workflow steps resulting in said future workflow states, wherein said probability determination uses previous workflow execution logs for determining a plurality of author access probabilities for a plurality of authors indicative of a probability that an author accesses said content item;
determining a data center performance indicator for each of a plurality of data centers enabled for storing said content item;
determining a content item storage indicator using said determined probabilities and said determined data center performance indicator for each of said plurality of data centers; and
storing said content item in that data center which related content item storage indicator exceeds a predefined threshold value.

2. The method according to claim 1, wherein said workflow comprises at least one alternative sub-workflow to reach a final status starting from an initial status.

3. The method according to claim 1, wherein each of said data centers is selected from a list of data centers already used for storage of said content item.

4. The method according to claim 1, wherein at least one of said data centers is selected from a list of data centers not yet used for a storage of said content item, or if not any suitable data center is found in said list of data centers not yet used for a storage of said content item, said method further comprises:
recommending to open a new data center compliant to said predefined threshold value.

5. The method according to claim 1, wherein each of said data center performance indicators for said data center is at least one selected out of the group comprising a latency in a communication network between a user device and said data center, a risk of natural disaster at a location of said data center, geographical location, cost of operation of said data center and fulfilment of predefined rules, or a combination thereof.

6. The method according to claim 1, wherein each of said performance indicators of a data center is estimated based on historic values, estimated based on forecast values or calculated based on actual measurement values over time.

7. The method according to claim 1, wherein said determining said performance indicator comprises:
determining satisfaction ratings between each of a plurality of key performance indicators of said data center in comparison to a related requirement relating to said content item;
building a sum of all satisfaction ratings; and
sorting said data centers into an ordered list depending on said sum of all related satisfaction ratings.

8. The method according to claim 1, wherein a cognitive engine is used for determining a trend of said data center performance indicator.

9. The method according to claim 1, wherein said determining probabilities for future workflow states is based on a function comprising a collaboration coefficient indicative of a relationship between a first author and a second author working in content items in a given workflow.

10. The method according to claim 1, further comprising:
creating a script for storing said content item in one or more data centers exceeding said predefined threshold value after every finished workflow step.

11. A system for assigning a content item to a data center and for storing said content item in said data center, said system comprising:
a reading unit adapted for reading a workflow definition for content items in a content management system, wherein said workflow definition comprises a plurality of states for a content item;
a first determination engine adapted for determining a state of said content item in its related workflow;
a second determination engine adapted for determining probabilities for future workflow states of said content items using author profiles performing future workflow steps resulting in said future workflow states, wherein said second determination engine is also adapted for using previous workflow execution logs for determining a plurality of author access probabilities for a plurality of authors indicative of a probability that an author accesses said content item;
a third determination engine adapted for determining a data center performance indicator for each of a plurality of data centers enabled for storing said content item;
a fourth determination engine adapted for determining a content item storage indicator using said determined probabilities and said determined data center performance indicator for each of said plurality of data centers; and
a storage unit adapted for storing said content item in that data center which related content item storage indicator exceeds a predefined threshold value.

12. The system according to claim 11, wherein said workflow comprises an alternative sub-workflow to reach a final status starting from an initial status.

13. The system according to claim 11, wherein each of said data centers is selected from a list of data centers already used for a storage of said content item or from a list of data centers not yet used for a storage of said content item, or wherein said system comprises a recommendation unit adapted for recommending to open a new data center compliant to said predefined threshold value, if not any suitable data center is found in said list of data centers not yet used for a storage of said content item.

14. The system according to claim 11, wherein each of said data center performance indicators for said data center is at least one selected out of the group comprising a latency in a communication network between a user device and said data center, a risk of natural disaster at a location of said data center, cost of operation of said data center and fulfilment of predefined rules, or a combination thereof.

15. The system according to claim 11, wherein each of said performance indicators of data centers is estimated based on historic values, estimated based on forecast values or calculated based on actual measurement value over time.

16. The system according to claim 11, wherein said third determination engine adapted for determining said data center performance indicator is also adapted for:
determining satisfaction ratings between each of a plurality of key performance indicators of said data center in comparison to a related requirement relating to said content item;
building a sum of all satisfaction ratings; and
sorting said data centers into an ordered list depending on said sum of all related satisfaction ratings.

17. The system according to claim 11, also comprising a cognitive engine adapted for determining a trend of said data center performance indicator.

18. The system according to claim 11, wherein said second determination engine for determining probabilities for future workflow states is also adapted for basing its determination on a function comprising a collaboration coefficient indicative of a relationship between a first author and a second author working in content items in a given workflow.

19. The system according to claim 11, further comprising a creation unit adapted for:
creating a script for storing said content item in those data centers exceeding said predefined value after every finished workflow step.

20. A computer program product for assigning a content item to a data center and for storing said content item in said data center, said computer program product comprising a computer readable storage medium having program instructions embodied therewith, said program instructions being executable by one or more computing systems to cause said one or more computing systems to:
read a workflow definition for content items in a content authoring service, wherein said workflow definition comprises a plurality of states for a content;
determine a state of one of said content items in its related workflow;
determine probabilities for future workflow states of said content item using author profiles performing future workflow steps resulting in said future workflow states, wherein said probability determination uses previous workflow execution logs for determining a plurality of author access probabilities for a plurality of authors indicative of a probability that an author accesses said content item;
determine a data center performance indicator for each of a plurality of data centers enabled for storing said content item;
determine a content item storage indicator using said determined probabilities and said determined data center performance indicator for each of said plurality of data centers; and
store said content item in that data center which related content item storage indicator exceeds a predefined threshold value.
